(19) United States
(12) Patent Application Publication
(10) Pub. No.: US 2003/0159311 A1
(43) Pub. Date: Aug. 28, 2003

(54) Rocking type grain drier

(76) Inventor: Chun-Chien Yu, Taichung (TW)

Correspondence Address: BACON & THOMAS, PLLC, 625 SLATERS LANE, FOURTH FLOOR, ALEXANDRIA, VA, 22314

(21) Appl. No.: 10/083,365

(22) Filed: Feb. 27, 2002

(51) Int. Cl. F26B 17/00

(52) U.S. Cl. 34/576; 34/583; 34/588

(57) ABSTRACT

A grain drier comprises two main bodies and a rocking device for actuating the main bodies to rock. The main bodies are mounted on a stand and are provided in the hollow interior with a plurality of bellows-like devices, with each having a hot air admitting port and a plurality of air holes for circulating the hot air stream so as to effect the process of drying the grain deposited on the outer side surface of the slantingly-arranged bellows-like device. The rocking device is fastened with the stand.

### FIELD OF THE INVENTION

The present invention relates generally to a grain drier, and more particularly to a rocking type grain drier.

### BACKGROUND OF THE INVENTION

As shown in FIG. 1, a vibrating type grain drier 3 of the prior art comprises a grain-feeding port 32 in communication with a ventilation port 33 and s first sieve 34. The grain is deposited on the sieve 34 via the grain-feeding port 32 such that the grain is separated from the foreign matters which are mixed with the grain. The grain drier 3 is vibrated by a vibrating device 4 to cause the grain to tremble on a plurality of sieves 34. In the meantime, the grain is dried by the hot air generated by a heater 5. The foul air is driven out via the ventilation port 33. The dried grain is then discharged via an exit 38 such that the dried grain is carried away by a conveyor 6 via a connection pipe 37 in conjunction with two connection shafts 361 and 362.

Such a prior art grain drier as described above is defective in design in that the hot air generated by the heater 5 is not evenly distributed to all sieves 34, and that the moisture is not effectively removed from the interior of the drier 3 via the ventilation port 33. As a result, the prior art grain drier is incapable of drying grain rapidly in quantity. In addition, the vibrating device 4 is not energy-efficient, thereby resulting in high cost of operation. Moreover, the grain can not be effectively caused to move down the sieves 34, thereby obstructing the movement of the incoming grain. The foreign matters, which are separated from the grain by an upper sieve 34, are apt to deposit on a lower sieve 34.

### SUMMARY OF THE INVENTION

The primary objective of the present invention is to provide a rocking type grain drier which is free of the deficiencies of the prior art grain drier described above.

It is another objective of the present invention to provided a grain drier which is efficient and cost-effective.

In keeping with the principle of the present invention, the foregoing objectives of the present invention are attained by a rocking type grain drier comprising a plurality of bellows-like devices which are arranged alternately at an inclination. Each of the bellows-like device is provided with a plurality of air-discharging holes, and a dry admitting port via which the dry air stream is introduced into the bellows-like device for drying the grain which is deposited on the bellows-like device. The circulation of the air stream is attained by the air-discharging holes of the bellows-like device. The drying of the grain is effectively carried out by the bellows-like devices in conjunction with a rocking device.

The features and the advantages of the present invention will be more readily understood upon a thoughtful deliberation of the following detailed description of the present invention with referrence to the accompanying drawings.

### BRIEF DESCRIPTION OF THE DRAWINGS

FIG. 1 shows a sectional schematic view of the vibrating type grain drier of the prior art.

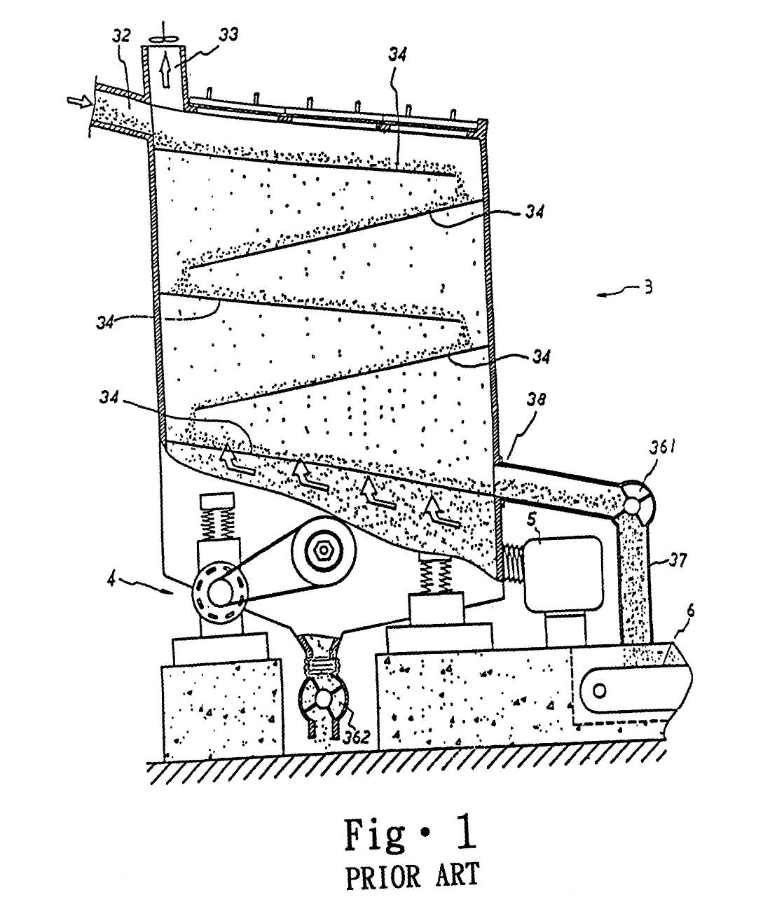

FIG. 2 shows a perspective view of a first preferred embodiment of the present invention.

FIG. 3 shows a sectional schematic view of the first preferred embodiment of the present invention.

FIG. 4 shows a top view of the first preferred embodiment of the present invention.

FIG. 5 shows an enlarged view of a portion indicated by a circle “A” as shown in FIG. 3.

FIG. 6 shows a schematic view of a cam transmission mechanism of the first preferred embodiment of the present invention.

FIG. 7 shows a schematic view of the rocking device of the preferred embodiment of the present invention at work.

FIG. 8 shows another schematic view of the rocking device of the preferred embodiment of the present invention at work.

FIG. 9 shows a schematic view of the first preferred embodiment of the present invention in operation.

FIG. 10 shows a top plan view of a second preferred embodiment of the present invention.

FIG. 11 shows a sectional schematic view of the second preferred embodiment of the present invention.

### DETAILED DESCRIPTION OF THE INVENTION

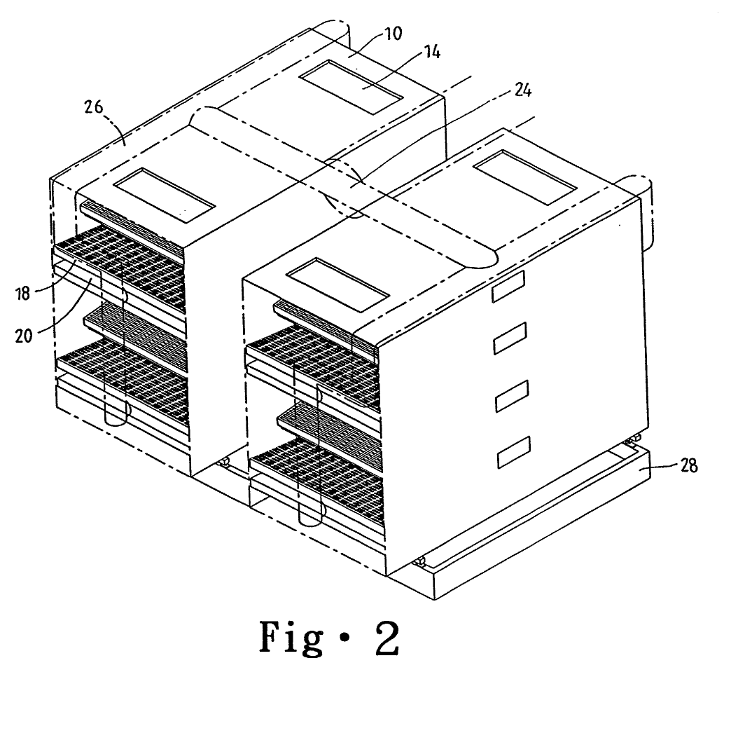

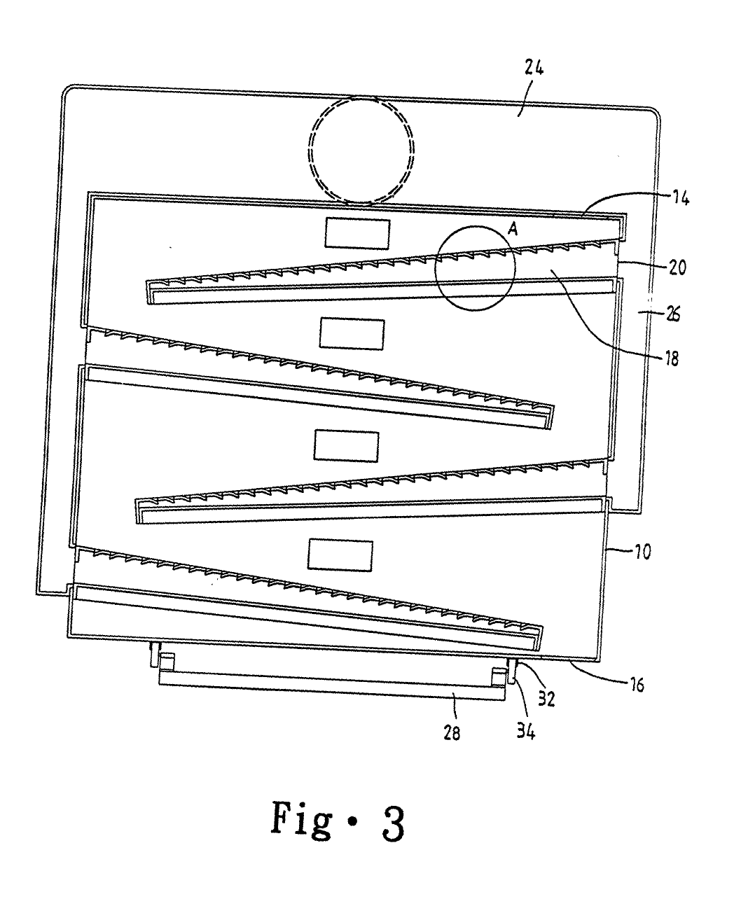

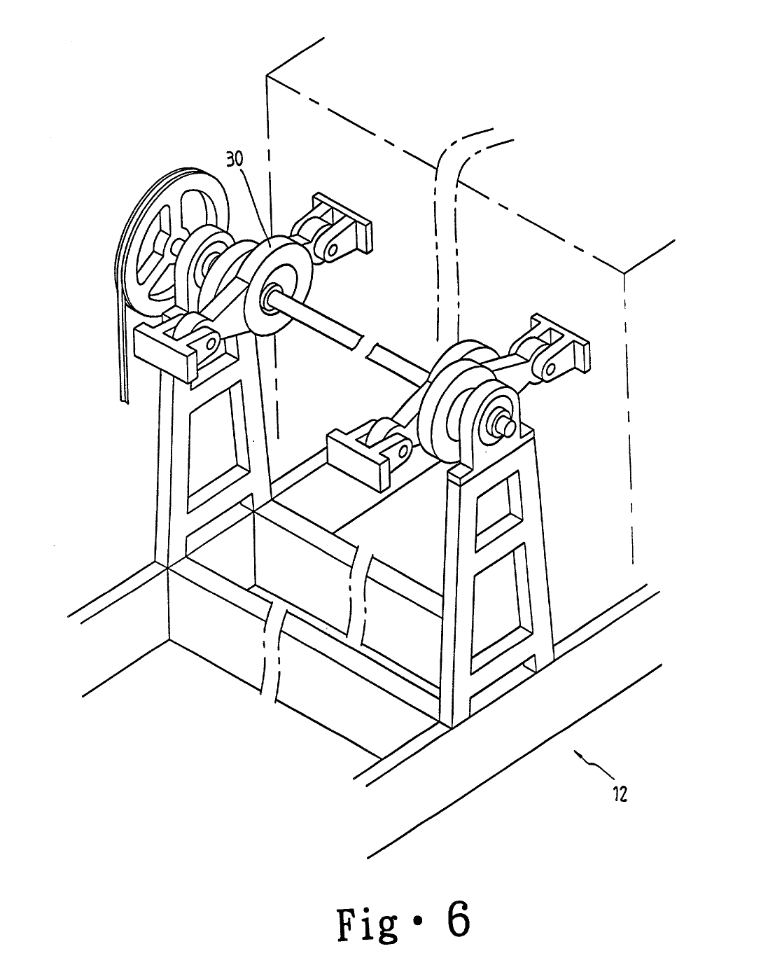

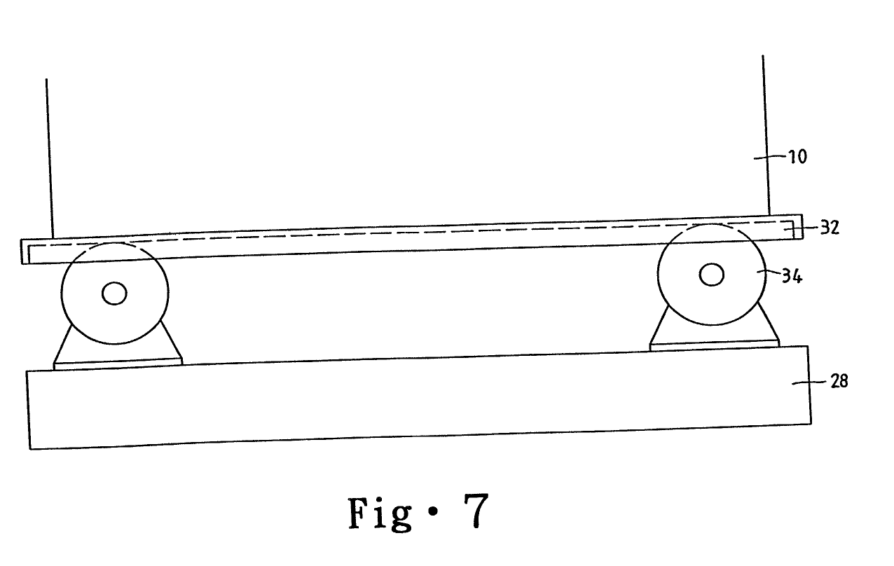

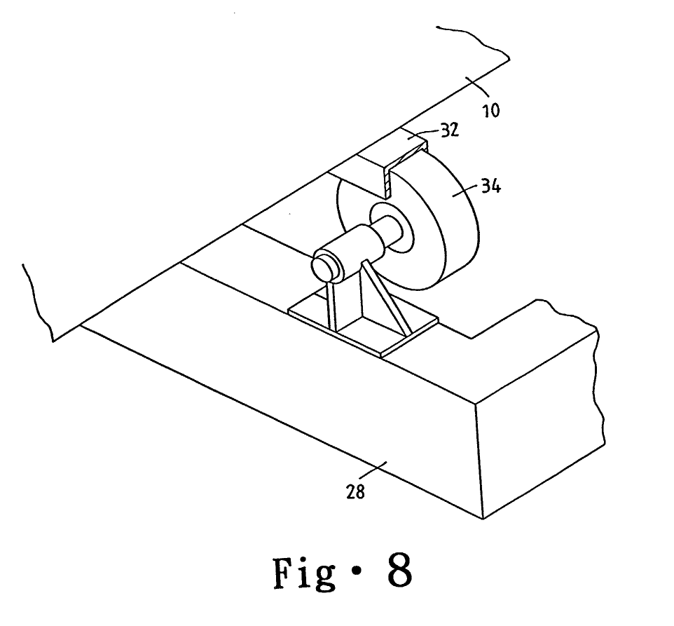

As shown in FIGS. 2-9, a grain drier of the present invention comprises two rectangular main bodies 10, and a rocking device 12.

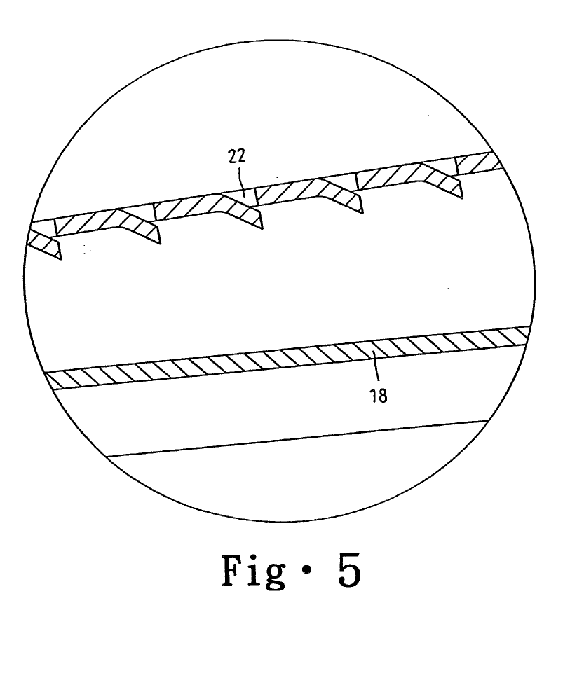

The two rectangular main bodies 10 are identical in construction to each other and are arranged longitudinally side by side. Each main body 10 is provided at the top with a feeding port 14, and at the bottom with an exit 16 in communication with a conveyor (not shown in the drawing). The feeding port 14 is in communication with a hollow interior of the main body 10, which is provided with a plurality of bellows-like devices 18. The bellows-like devices 18 are arranged alternately at an inclination. The bellows-like devices 18 are provided at the higher end thereof with a dry air admitting port 20 via which a dry hot air stream is introduced into the device 18. The device 18 is provided in the upper side with a plurality of air-discharging holes 22, as shown in FIG. 5. The dry air admitting port 20 is connected with a hot air pipe 24 of a central hot air pipe 24 which is connected with two main bodies 10. The air circulation of the bellows-like device 18 is brought about by the air-discharging holes 22, so as to effect the drying of the grain which is deposited on the upper side surface of the bellows-like device 18.

The rocking device 12 is connected with the main bodies 10 and is provided with a cam transmission mechanism 30, which comprises two rails 32 and four slide wheels 34 located at four corners of a stand 28. The main bodies 10 are periodically rocked by the rocking device 12 such that the main bodies 10 slide by means of the rails 32 between the slide wheels 34. The main bodies 10 are mounted on the stand 28.

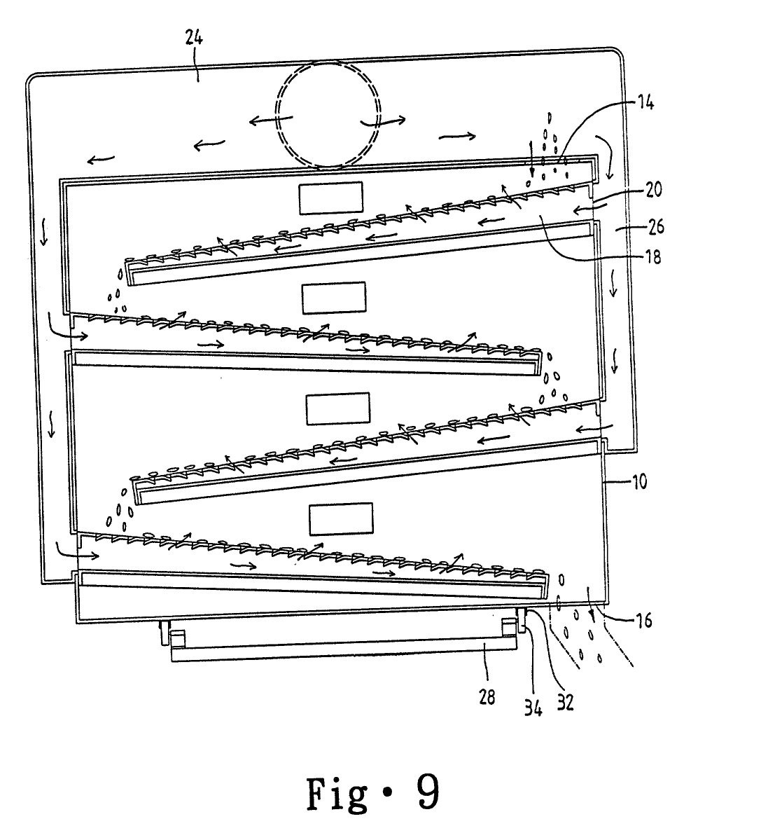

As illustrated in FIG. 9, the grain is fed into the main body 10 via the feeding port 14 such that the grain is deposited on the topmost bellows-like device 18, and that the grain is dried by the dry hot air stream circulating through the air-discharging holes 22 of the bellows-like device 18. The grain is eventually moved by the rocking motion to the lower end of the bellows-like device 18, from which the grain falls on the high end of a lower bellows-like device 18. The process of drying the grain is effected by a series of bellows-like devices 18, which are arranged alternately and slantingly.

In light of the outer end edge of the air-discharging holes 22 of the bellows-like devices 18 being flush with the upper side surface of the bellows-like devices 18, the grain is dried evenly and rapidly. In addition, the bellows-like devices 18 are independent of one another and are respectively provided with a dry air admitting port 20, the dry hot air stream is uniformly distributed to all bellows-like devices 18 from the central hot air pipe 24. In addition, the grain drier of the present invention is cost-effective in design in that two main bodies 10 are simultaneously rocked by one rocking device 12.

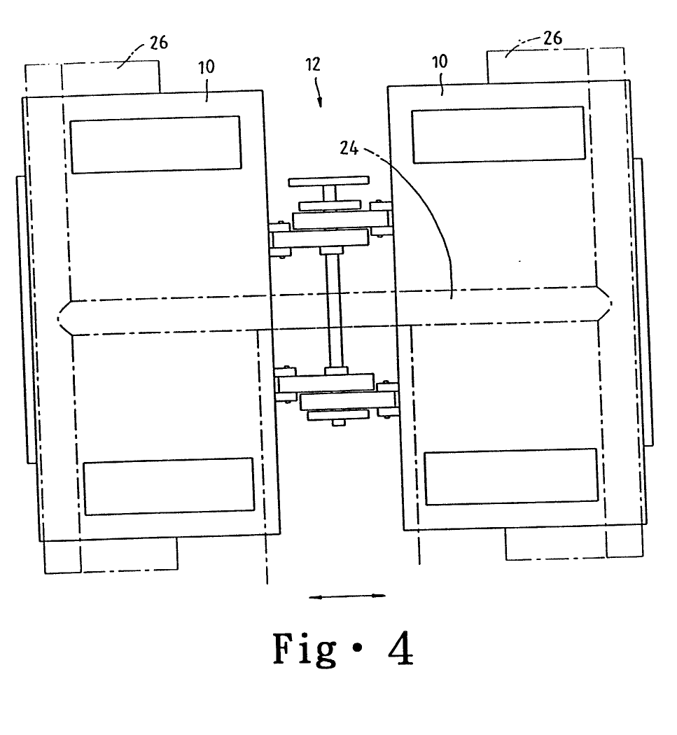

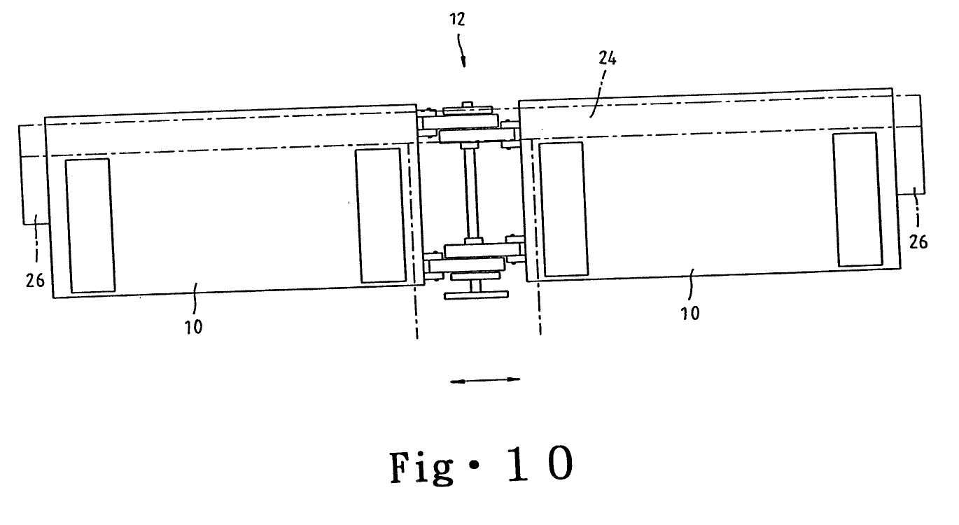

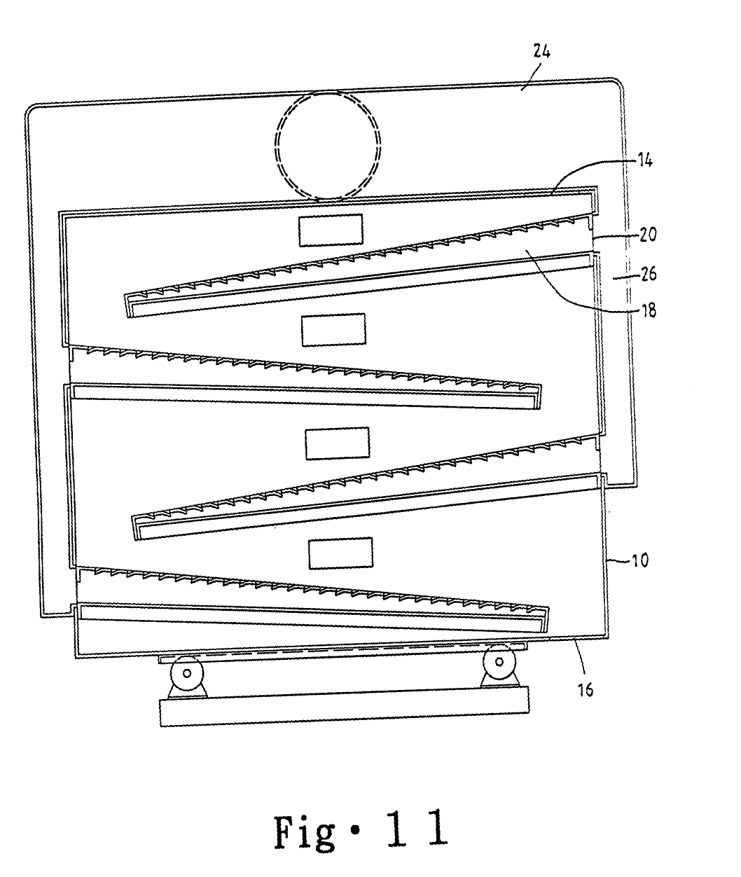

The present invention described above is to be regarded in all respects as being illustrative and nonrestrictive. Accordingly, the present invention may be embodied in other specific forms without deviating from the spirit thereof. For example, the longitudinally-arranged main bodies 10, as shown in FIG. 4, may be arranged horizontally, as shown in FIGS. 10 and 11. The present invention is therefore to be limited only by the scopes of the following claims.

What is claimed is:

1. A grain drier comprising:
two rectangular main bodies arranged longitudinally and side by side, said two main bodies being identical to each other in construction and being provided with a hollow interior, a grain-feeding port in communication with said hollow interior, and a grain exit in communication with said hollow interior whereby said main bodies are provided in said hollow interior thereof with a plurality of bellows-like devices arranged alternately and slantingly, said bellows-like devices provided at one end with a hot air admitting port and in an upper said surface with a plurality of air holes in communication with said hot air admitting port which is in communication with a central hot air pipe for provided said bellows-like devices with a hot air stream to flow through said air holes of said upper side surface to effect the drying of the grain deposited on said upper side surface of said bellows-like devices; and
a rocking device fastened with said two main bodies for rocking said two main bodies so as to cause the grain to move downward along said upper side surface of said bellows-like devices.

2. The grain drier as defined in claim 1, wherein said two main bodies are mounted on a stand; wherein said rocking device comprises two rails and four slide wheels, with said two rails being mounted in two opposite sides of an underside of said stand, and with said four slide wheels being mounted at four corners of said stand whereby said two rails slide between two of said slide wheels.

3. The grain drier as defined in claim 1, wherein said air holes of said upper side surface of said bellows-like devices have an outer end edge flush with said upper side surface.
